(19) United States
(12) Patent Application Publication
(10) Pub. No.: US 2004/0080689 A1
(43) Pub. Date: Apr. 29, 2004

(54) Reflector and reflective liquid crystal display having the same

(76) Inventor: Wei-Chih Chang, Hsinchu (TW)

Correspondence Address: Michael D. Bednarek, Shaw Pittman LLP, 1650 Tysons Boulevard, McLean, VA, 22102, US

(21) Appl. No.: 10/684,487

(22) Filed: Oct. 15, 2003

(30) Foreign Application Priority Data
Oct. 25, 2002 (TW) 091124956

(51) Int. Cl. G02F 1/1335

(52) U.S. Cl. 349/113

(57) ABSTRACT

A reflective LCD includes a first substrate, a second substrate disposed opposite to the first substrate, and a liquid crystal layer interposed therebetween. A reflector having a flat portion and a convex/concave portion is formed over the first substrate. A plurality of gate lines and source lines are formed over the first substrate and across to each other. The gate lines and the source lines define a pixel region. The brightness and the reflectance of the reflective LCD can be adjusted by adjusting an area ratio of the flat portion to the pixel region.

### CROSS REFERENCE TO RELATED APPLICATIONS

This application claims priority to Taiwan Patent Application No. 091124956 entitled “Reflector and Reflective Liquid Crystal Display Using the Same”, filed on Oct. 25, 2002.

### FIELD OF THE INVENTION

The present invention generally relates to a reflector for a reflective liquid crystal display (LCD) and, more particularly, to a reflector and a reflective LCD having the same.

### BACKGROUND OF THE INVENTION

In recent years, liquid crystal display (LCD) devices have been widely applied to various devices, such as personal computers, household appliances, digital cameras, and so on. Implemented in whatever kind of application, lighter weight, smaller size, less power consumption, and lower cost are goals of developing the LCD. A reflective LCD, which works without a back light device, is one of the possible approaches. The reflective LCD utilizes ambient lights in the environment to eliminate the need of a back light module. As a result, the reflective LCD has a reduced weight and a smaller size, consumes less power, and reduces the cost of production.

However, how to efficiently utilize ambient lights in the environment is a key to meet the brightness requirement of a reflective LCD. A reflector in the LCD plays a very important role in the utilization of the ambient lights, and therefore there is a need to provide a reflector with excellent reflection characteristic, which utilizes the ambient light efficiently.

A conventional reflector has a bumpy surface constituted by pellets or recesses, which are usually made of photosensitive resin materials. A thin film is then deposited on the bumpy surface and makes it a little smoother.

However, a design without appropriate considerations generally renders the performance of the LCD unreliable. For example, as the misalignment of the liquid crystals occurs, the LCD might have appropriate brightness but low contrast, or have appropriate contrast but low brightness. In some cases, even if the LCD has appropriate brightness and contrast, it might respond slowly, have a threshold voltage too high, or display images non-uniformly.

Furthermore, different from a transmissive LCD using a back light module as a light source, the reflective LCD utilizes the ambient light. When the reflective LCD is operated in a dim or dark environment, images or data displayed easily become vague. Thus, the reflective LCD equipped with a front light source is devised.

The front light source makes the reflective LCD able to clearly display images in a dark environment. However, lights provided by the front light source are scattered lights in a certain view angle. After the reflector reflects the lights from the front light source, the view angle of lights are widened, and the brightness is decreased. Therefore, there is a need to provide a reflector to increase the brightness of an LCD.

### SUMMARY OF THE INVENTION

It is one aspect of the present invention to provide a reflector and a reflective LCD having the reflector. The reflective LCD includes a substrate, a reflector on the substrate, gate lines, source lines, and transistors. The gate lines and the source line cross each other to define a pixel region. The reflector is disposed in the pixel region and configured to reflect lights. The reflector includes a flat portion and a convex/concave portion.

The flat portion of the reflector serves as a specific region where substantially no convex pellet or concave recess exists. Furthermore, the total area of the flat portion and the convex/concave portion equals the area of the pixel region.

For a reflective LCD with a front light source, when the light source is turned on, a light guide plate scatters light provided by the light source, so the light shines on the reflector, and is then reflected. The front light source generally works in a dim or dark environment, and if light reflected by the reflector is not bright enough to illuminate the LCD panel, images shown in the LCD are vague. Therefore, the flat portion of the reflector can improve the brightness of an LCD.

For a reflective LCD demanding high brightness, an area ratio of the flat portion to the pixel region is in a range from about 20% to 70%. For a reflective LCD demanding both brightness and reflectance, an area ratio of the flat portion to the pixel region is in a range from about 0% to 20%.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an exemplary reflective LCD of the present invention;

FIG. 2 illustrates a cross-sectional view along line I-I′ of FIG. 1;

FIG. 3 illustrates a schematic view of operating with a front light source in one embodiment of the present invention; and

FIG. 4 illustrates a diagram showing the relationship of brightness, reflectance, and the area ratio of a flat portion to a pixel region.

### DETAILED DESCRIPTION OF THE INVENTION

The present invention provides a reflector and a reflective LCD having the reflector. In one embodiment, FIG. 1 illustrates an exemplary reflective LCD 100, which includes a first substrate 10, a reflector 15 on the first substrate 10, a plurality of gate lines 32, a plurality of source lines 34, and a plurality of transistors 36. The gate lines 32 and the source lines 34 cross each other to define a pixel region 30. The reflector 15 is disposed within the pixel region 30 and configured to reflect lights. The reflector 15 includes a flat portion 11 and a convex/concave portion 13.

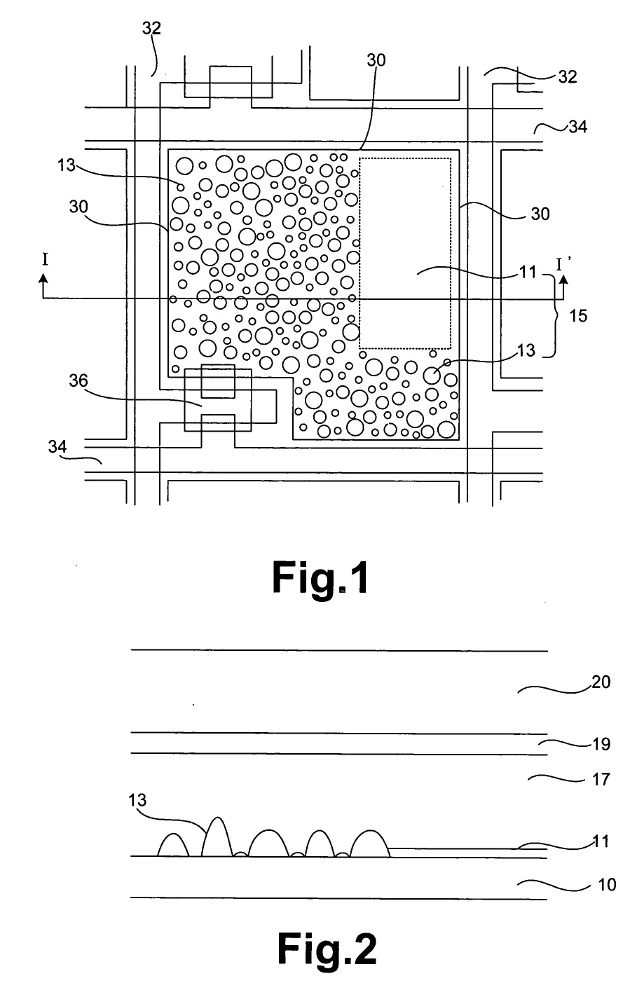

FIG. 2 illustrates a cross-sectional view along line I-I′ of FIG. 1. As shown in FIG. 2, the reflective LCD 100 includes the first substrate 10 like glass substrate or any substrate as appropriate. The reflector 15 having the flat portion 11 and the convex/concave portion 13 is formed over the first substrate 10. The material of reflector 15 can include resin or the like. Furthermore, the reflective LCD 100 includes a second substrate 20 and a transparent conductive layer 19 thereon. The second substrate 20 is disposed opposite to the first substrate 10, and a liquid crystal layer 17 interposed between these two substrates 10 and 20. The transparent conductive layer 19 includes an indium tin oxide (ITO) layer, or the like.

In this embodiment, the flat portion 11 serves as a specific region in the reflector 15. There is substantially no pellet or recess existing in the flat portion 11. Moreover, the total area of the flat portion 111 and the convex/concave portion 13 equals to the area of the pixel region 30.

The flat portion 11 and the convex/concave portion 13 are both configured to reflect light. Different from the flat portion 11, which reflects light without reducing brightness, the convex/concave portion 13 scatters light, so that the scattered light is more uniform but less bright. In other words, in a reflective LCD, the flat portion 11 of the reflector 15 is implemented to compensate for insufficient brightness.

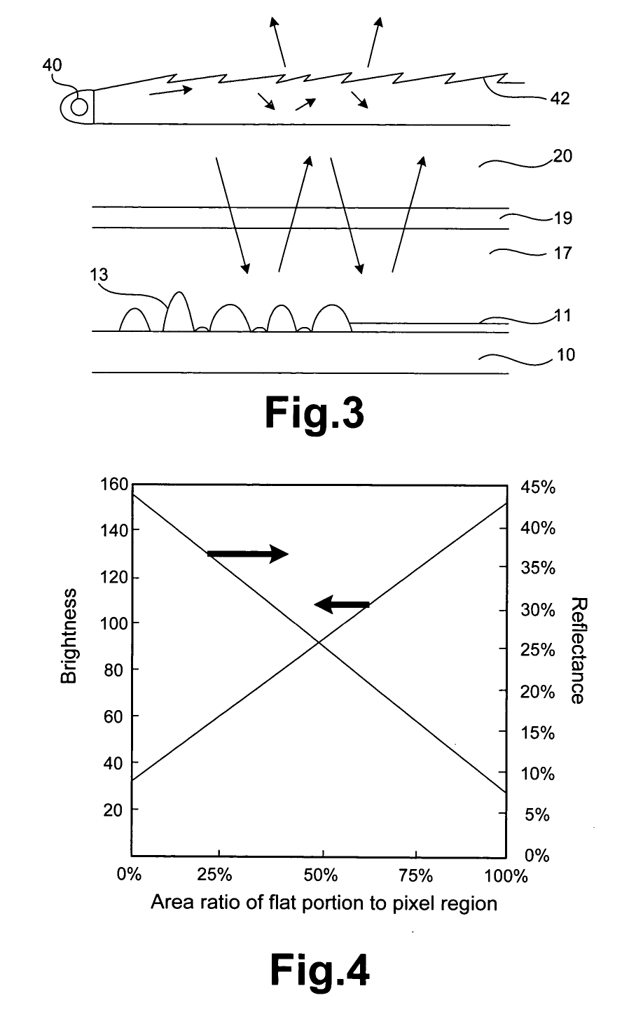

For example, as shown in FIG. 3, the reflective LCD has a front light source 40. When the front light source 40 is turned on, a light guide plate 42 scatters light provided by the front light source 40, so the light shines on the reflector 15, and is then reflected. The front light source 40 generally works in a dim or dark environment, and if the light reflected by the reflector 15 is not bright enough to illuminate the LCD panel, images shown in the LCD will be vague. Therefore, the flat portion 11 of the reflector 15 can improve the brightness of LCDs.

However, the area ratio of the flat portion 11 to the pixel region 30 significantly affects the brightness and reflectance of an LCD. FIG. 4 illustrates diagram showing the relationship of the brightness, the reflectance, and the area ratio of the flat portion 11 to the pixel region 30. The horizontal axis represents the area ratio of the flat portion 11 to the pixel region 30. The vertical axis on the left represents the brightness, and the vertical axis on the right represents the reflectance. As shown in FIG. 4, as the area ratio of the flat portion 11 to the pixel region 30 decreases, the reflectance is increased, and the brightness is decreased. On the other hand, as the area ratio of the flat portion 11 to the pixel region 30 increases, the reflectance is decreased, and the brightness is increased.

Therefore, according to different design needs, by adjusting the area ratio of the flat portion 11 to the pixel region 30, the control over the brightness and the reflectance can be achieved. In general, for a reflective LCD demanding high brightness, the area ratio of the flat portion to the pixel region is in a range from about 20% to 70%. For a reflective LCD demanding both of brightness and reflectance, the area ratio of the flat portion to the pixel region is in a range from about 0% to 20%.

Although specific embodiments have been illustrated and described, it will be obvious to those skilled in the art that various modifications may be made without departing from what is intended to be limited solely by the appended claims.

What is claimed is:

1. A reflector, comprising:
a substrate having a pixel region;
a flat portion formed over said substrate; and
a convex/concave portion formed over said substrate;
wherein the total area of said flat portion and said convex/concave portion equals the area of the pixel region.

2. The reflector of claim 1, wherein an area ratio of said flat portion to said pixel region is in a range from 0% to 20%.

3. The reflector of claim 1, wherein an area ratio of said flat portion to said pixel region is in a range from 20% to 70%.

4. A reflective liquid crystal display device, comprising:
a first substrate having a pixel region;
a flat portion formed over said first substrate; and
a convex/concave portion formed over said first substrate;
wherein the total area of said flat portion and said convex/concave portion equals the area of the pixel region.

5. The reflective liquid crystal display device of claim 4, wherein an area ratio of said flat portion to said pixel region is in a range from 0% to 20%.

6. The reflective liquid crystal display device of claim 4, wherein an area ratio of said flat portion to said pixel region is in a range from 20% to 70%.

7. The reflective liquid crystal display device of claim 4, further comprising a second substrate disposed opposite to said first substrate.

8. The reflective liquid crystal display device of claim 7, further comprising a liquid crystal layer interposed between said first substrate and said second substrate.

9. The reflective liquid crystal display device of claim 8, further comprising a front light source, wherein said flat portion and said convex/concave portion reflect lights provided by said front light source.

10. A reflective liquid crystal display device, comprising:
a first substrate having a pixel region;
a flat portion formed over said first substrate; and
a convex/concave portion formed over said first substrate;
wherein the total area of said flat portion and said convex/concave portion equals the area of the pixel region, and an area ratio of said flat portion to said pixel region is in a range from 0 to 70%.

11. The reflective liquid crystal display device of claim 10, further comprising a second substrate disposed opposite to said first substrate.

12. The reflective liquid crystal display device of claim 11, further comprising a liquid crystal layer interposed between said first substrate and said second substrate.

13. The reflective liquid crystal display device of claim 12, further comprising a front light source, wherein said flat portion and said convex/concave portion reflect lights provided by said front light source.
